(19) United States
(12) Patent Application Publication
(10) Pub. No.: US 2007/0131500 A1
(43) Pub. Date: Jun. 14, 2007

(54) Rotary damper

(75) Inventors: Hong-Che Yen, Taipei (TW); Yu-Chih Cheng, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/365,784

(22) Filed: Mar. 1, 2006

(30) Foreign Application Priority Data
Dec. 9, 2005 (TW) 094143535

(51) Int. Cl. F16D 57/06

(52) U.S. Cl. 188/295

(57) ABSTRACT

A rotary damper for use in a device having a lid-uplifting design includes a spring, a rotary member, a casing and a rubber ring. The spring is arranged between the rotary member and the casing. The rubber ring is sheathed around the rotary member. The rotary damper is capable of slowly opening a lid because the rubber ring is useful to provide the rotational resistance and the torsion or elastic relaxation of the spring results in a rotary motion of the rotary member.

### FIELD OF THE INVENTION

The present invention relates to a rotary damper for opening a lid, and more particularly to a rotary damper a rotary damper for slowly opening a lid by using a rubber ring to provide the rotational resistance.

### BACKGROUND OF THE INVENTION

In a lid-lifting design of a mobile phone or a device having a storing function, a rotary damper is usually used for applying rotational resistance to a hinge shaft of the lid, so that the lid is not suddenly closed or opened. For example, Taiwanese Patent Gazette No. 549376 discloses a rotary damper including a casing and a rotary member. The casing has a cylindrical chamber defined therein. A resilient element is accommodated within the cylindrical chamber and a viscous fluid is filled in the cylindrical chamber. During the lid is opened, compression or elastic relaxation of the resilient element results in a rotary motion of the rotary member. Since the viscous shearing resistance is generated in the viscous fluid, the lid can be opened or uplifted slowly.

Unfortunately, since the viscous fluid is readily subject to leakage from the cylindrical chamber, the lid is contaminated or the whole product may be damaged.

In views of the above-described disadvantages of the prior art, the applicant keeps on carving unflaggingly to develop a rotary damper according to the present invention through wholehearted experience and research.

### SUMMARY OF THE INVENTION

An object of the present invention is to provide a rotary damper for preventing the viscous fluid from leakage.

Another object of the present invention is to provide a rotary damper for slowly opening a lid by using a rubber ring to provide the rotational resistance.

In accordance with an aspect of the present invention, there is provided a rotary damper. The rotary damper comprises a spring, a rotary member, a rubber ring, a casing and an end cap. The rotary member includes a receptacle defined at one end thereof, wherein the spring is accommodated with the receptacle and has a first terminal anchored to the inner wall of the receptacle. The rubber ring is sheathed around the other end of the rotary member. The casing includes a cylindrical chamber defined therein. The cylindrical chamber has a mouth portion. The spring and a portion of the rotary member are accommodated within the cylindrical chamber. The spring has a second terminal anchored to the bottom surface of the cylindrical chamber. The periphery of the rubber ring is sustained against the inner wall of the cylindrical chamber. The end cap is coupled to the mouth portion for sealing a portion of the rotary member, the rubber ring and the spring within the cylindrical chamber, wherein the end cap has an opening allowing the rotary member to be penetrated therethrough.

In an embodiment, the first and second terminals of the spring include hook structures to be engaged with corresponding recess structures within the receptacle and the cylindrical chamber.

In an embodiment, the periphery of the end cap further comprises protrusion blocks embedded into corresponding indentation structures on the mouth portion of the cylindrical chamber.

In an embodiment, the rotary damper further comprises two oil rings at the upper and lower sides of the rubber ring.

In an embodiment, the rotary member and the casing further comprise retaining structures.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is an exploded view of a rotary damper according to a preferred embodiment of the present invention;

FIG. 1B is a perspective view of a rotary damper according to a preferred embodiment of the present invention;

FIG. 1C is a cross-sectional view of a rotary damper according to a preferred embodiment of the present invention; and

FIGS. 2A and 2B are perspective views of the rotary dampers according to two further preferred embodiment of the present invention, in which the rotary member and the casing further include retaining structures.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed. The schematic drawings, not to scale, are employed to illustrate the specific features of the present invention. In addition, the elements or structures in the drawings are not limited to the precise form disclosed. Unless specifically stated, the individual element may be extensive to include multiple elements or structures.

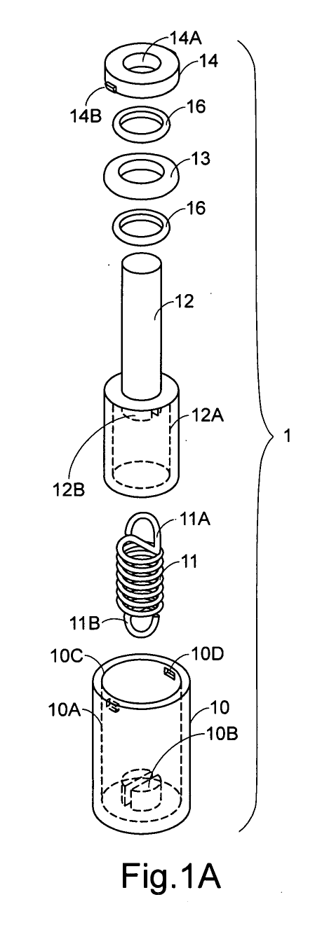

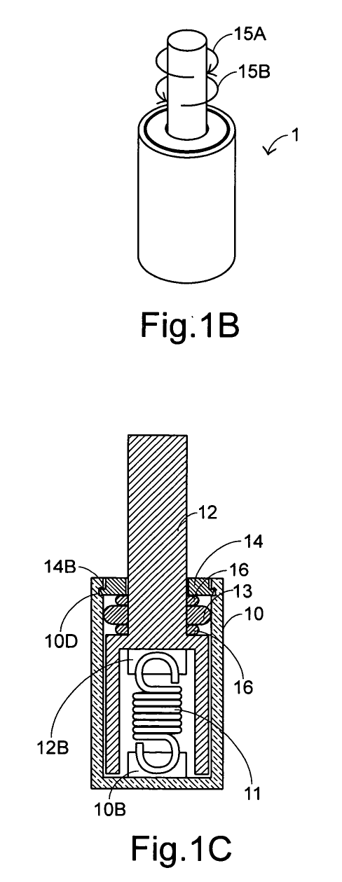

Please refer to FIGS. 1A, 1B and 1C, which are exploded, perspective and cross-sectional views of a rotary damper according to a preferred embodiment of the present invention. In the exploded view of FIG. 1A, the rotary damper 1 comprises a casing 10, a spring 11, a rotary member 12, a rubber ring 13 and an end cap 14. One end of the rotary member 12 has a receptacle 12A defined therein. The inner diameter of the receptacle 12A is slightly larger than the diameter of the spring 11, so that the spring 11 is accommodated within the receptacle 12A. In addition, the casing 10 has a cylindrical chamber 10A defined therein. The inner diameter of the cylindrical chamber 10A is slightly larger than the outer diameter of the receptacle 12A, so that a portion of the rotary member 12 and the spring 11 are accommodated within the cylindrical chamber 10A.

Please refer to FIGS. 1A and 1B. For a purpose of anchoring the spring 11, the ends 11A and 11B of the spring 11 may have hook structures. Correspondingly, recess structures 12B and 10B are formed within the receptacles 12A and 10A to be engaged with the hook structures 11A and 11B of the spring 11, respectively. Under this circumstance, if a torsion force is applied on the spring 11 along the clockwise direction 15A, the spring 11 is twisted. When this torsion force is relieved, the spring 11 will return to its original position such that the rotary member 12 is simultaneously rotated along the anti-clockwise direction. It is noted that, however, those skilled in the art will readily observe that numerous modifications and alterations for anchoring the spring 11 may be made while retaining the teachings of the invention. For example, the ends 11A and 11B of the spring 11 may have bar-like structures engaged with corresponding retaining clamps within the receptacles 12A and 10A, respectively. Accordingly, the above disclosure should be limited only by the bounds of the following claims.

As shown in FIGS. 1A and IC, the rubber ring 13 has been previously sheathed around the rod body of the rotary member 12 before a portion of the rotary member 12 and the spring 11 are accommodated within the cylindrical chamber 10A of the casing 10. It is preferred that the rubber ring 13 is sheathed around the rod body of the rotary member 12 in the vicinity of the receptacle 12A and has an outer diameter substantially identical to or slightly larger than the inner diameter of the cylindrical chamber 10A, so that the rubber ring 13 is sustained against the inner wall of the cylindrical chamber 10A. Since the rubber ring 13 facilitates providing the rotational resistance, the rotational speed of the rotary member 12 is slowed down upon rotation. Accordingly, in a case that the rotary member 12 is coupled to a lid of a mobile phone, the lid will be slowly opened or uplifted.

Please refer to FIGS. 1A and 1C again. The end cap 14 has an opening 14A in the center. After the spring 11, a portion of the rotary member 12 and the rubber ring 13 are accommodated within the cylindrical chamber 10A, the rotary member 12 is penetrated through the opening 14A of the end cap 14 so as to seal these components within the cylindrical chamber 10A. In this embodiment, the periphery of the end cap 14 further comprises protrusion blocks 14B to be embedded into corresponding indentation structures (or holes) 10D on the mouth portion 10C of the cylindrical chamber 10A. Alternatively, the end cap 14 is directly retained by the mouth portion 10C of the cylindrical chamber 10A.

Moreover, as shown in FIGS. 1A and 1C, the rotary damper 1 further comprises two oil rings 16 at the upper and lower sides of the rubber ring 13, so that the rubber ring 13 is not in direct contact with the rotary member 12 and the end cap 14. Under this circumstance, the friction force generated from the rubber ring 13 upon rotation is reduced. Alternatively, the inner periphery of the rubber ring 13 may be coated with a small amount of lubricant or viscous fluid (not shown), thereby reducing the friction between the rubber ring 13 and the rotary member 12. Due to the friction reduction, the rotary member 12 will be smoothly rotated.

From the assembled view of the rotary damper 1 as shown in FIG. 1B, the rotary member 12 is penetrated through the opening 14A of the end cap 14. In a case that a torsion force is applied on the spring 11 along the clockwise direction 15A, for example when the lid is closed and situated in a locked state, the spring 11 is twisted. Whereas, if the this torsion force is relieved, for example when the lid is situated in the unlocked state, the spring 11 will return to its original position. Meanwhile, the rotary member 12 is rotated along the anti-clockwise direction and the lid is slowly opened.

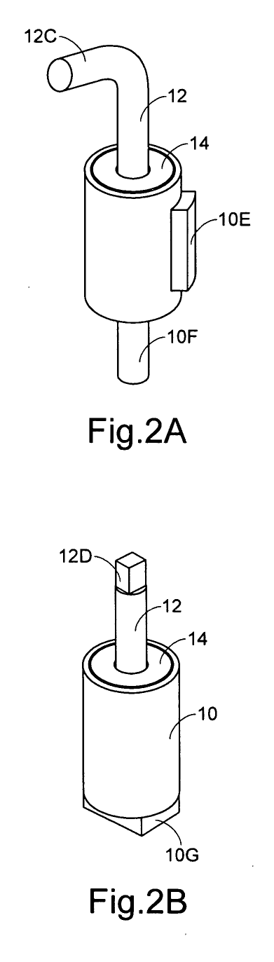

Moreover, depending on the manufacturer's design, the rotary member 12 and the casing 10 may further include retaining structures or coupling mechanisms in order to mount this rotary damper 1 onto the device having the foldable lid. A further embodiment of a rotary damper is illustrated in FIG. 2A. In this embodiment, the spring and the rubber ring included therein are similar to those shown in FIG. 1, and are not to be redundantly described herein. In addition, the rotary member 12 includes a retaining bar 12C extended from the top end thereof, and the casing 10 includes a raised block 10E and a shaft 12F on the bottom surface and the periphery thereof. By means of the retaining bar 12C, the raised block 10E and a shaft 12F, the rotary damper 1 will be retained or movably coupled to the device having the foldable lid. In another embodiment of FIG. 2B, the retaining structure or coupling mechanism includes a first prism block 12D and a second prism block 10G on the top end of the rotary member 12 and the bottom surface of the casing 10, respectively. After the retaining structure or coupling mechanism is mounted on the device having the foldable lid, the lid can be slowly opened due to coaxial rotation of the rotary member 12 and the casing 10.

From the above embodiments, the rotary damper of the present invention is capable of slowly opening a lid because the rubber ring is useful to provide the rotational resistance and the torsion or elastic relaxation of the spring results in a rotary motion of the rotary member. In addition, since a small amount of lubricant or viscous fluid is optionally coated onto the inner periphery of the rubber ring to reduce friction, the problems of causing considerable leakage of viscous fluid can be overcome.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A rotary damper comprising:
a spring;
a rotary member including a receptacle defined at one end thereof, wherein said spring is accommodated with said receptacle and has a first terminal anchored to the inner wall of said receptacle;
a rubber ring sheathed around the other end of said rotary member;
a casing including a cylindrical chamber defined therein, said cylindrical chamber having a mouth portion, wherein said spring and a portion of said rotary member are accommodated within said cylindrical chamber, said spring has a second terminal anchored to the bottom surface of said cylindrical chamber, and the periphery of said rubber ring is sustained against the inner wall of said cylindrical chamber; and
an end cap coupled to said mouth portion for sealing a portion of said rotary member, said rubber ring and said spring within said cylindrical chamber,
wherein said end cap has an opening allowing said rotary member to be penetrated therethrough.

2. The rotary damper according to claim 1 wherein said first and second terminals of said spring include hook structures to be engaged with corresponding recess structures within said receptacle and said cylindrical chamber, respectively.

3. The rotary damper according to claim 1 wherein the periphery of said end cap further comprises protrusion blocks embedded into corresponding indentation structures on said mouth portion of said cylindrical chamber.

4. The rotary damper according to claim 1 further comprising two oil rings at the upper and lower sides of said rubber ring.

5. The rotary damper according to claim 1 wherein said rotary member and said casing further comprise retaining structures.
